(19) United States
(12) Patent Application Publication
(10) Pub. No.: US 2010/0246732 A1
(43) Pub. Date: Sep. 30, 2010

(54) DETECTING APPARATUS AND METHOD IN MIMO SYSTEM

(75) Inventors: Bang-Won Seo, Daejon (KR); Hee-Soo Lee, Daejon (KR); Hyun-Kyu Chung, Daejon (KR); Dong-Woo Kim, Ansan-si (KR); Hong-Ju Lee, Ansan-si (KR)

Correspondence Address: LAHIVE & COCKFIELD, LLP;FLOOR 30, SUITE 3000, ONE POST OFFICE SQUARE, BOSTON, MA, 02109, US

(73) Assignees: Electronics and Telecommunications Research Institute, Daejon (KR); INDUSTRY-UNIVERSITY COOPERATION FOUNDATION HANYANG UNIVERSITY, Seoul (KR)

(21) Appl. No.: 12/438,331

(22) PCT Filed: Aug. 21, 2007
(86) PCT No.: PCT/KR2007/003992

§ 371 Date: Feb. 20, 2009

(30) Foreign Application Priority Data
Aug. 22, 2006 (KR) 10-2006-0079546
Nov. 14, 2006 (KR) 10-2006-0112379

(51) Int. Cl. H04B 1/10; H04L 27/28

(52) U.S. Cl. 375/341; 375/340; 375/260

(57) ABSTRACT

Provided are a detecting apparatus in a Multiple Input Multiple Output (MIMO) system and a method thereof. The apparatus includes a first detector for decoding a received signal, to thereby generate a decoded vector; a candidate elements decision unit for calculating an instantaneous signal-to-interference plus noise ratio (SINR) value for each element of the decoded vector, and deciding candidate elements for estimating a transmission data based on the decoded vector by comparing the calculated instantaneous SINR value and a threshold value; a signal eliminator for generating a signal with respect to the candidate elements determined in the candidate elements decision unit and outputting a modified signal by subtracting the signal from the received signal; and a second detector for decoding the modified signal received from the signal eliminator based on a more precise detection method than the first detector.

### TECHNICAL FIELD

The present invention relates to a detecting apparatus and method in a Multiple Input Multiple Output (MIMO) system; and, more particularly, to a detecting apparatus that maintains desired system performance and decreases the amount of computation for decoding received signals in a MIMO system which transmits and receives a plurality of symbols simultaneously by using multiple antennas and a method thereof.

### BACKGROUND ART

Generally, mobile communication terminals have a limited capacity of battery. As the amount of computation is increased, power consumption is increased, thus the amount of computation should be decreased.

Detecting methods in a Multiple Input Multiple Output (MIMO) system are studied similarly as multiple-user detecting methods of a Code Division Multiplexing Access (CDMA). The detecting methods include a zero forcing (ZF) method based on channel inverse matrix, and minimum mean-squared estimate (MMSE) method considering noise amplification in the ZF method. The ZF method and the MMSE method are linear detecting method. The linear detecting methods have the small amount of computation and can be easily implemented, but performance is not better than other detecting methods.

A maximum likelihood (ML) method calculates cost functions with respect to all combinations of transmission symbols and selects a combination having a minimum cost function. Complexity of the ML method is increased according to the number of constellation dots based on a modulation method and the number of transmitting antennas. Also, a sphere decoding (SD) method has similar performance as the ML method, but the amount of computation is very large. Thus, the SD method cannot be implemented in a real system.

A hybrid probabilistic data association (PDA)-sphere decoding (SD) method is proposed in an article by L. Georgios and S Nicholas, entitled “A hybrid probabilistic data association-sphere decoding detector for multiple-input-multiple-output systems.”, IEEE signal processing letters, Vol. 12, No. 4, pp. 309-312, April 2005. The first step of the PDA-SD method is to reduce the dimension of the vector decoded in SD by first running a single stage of the PDA. Herein, a bit to be decoded among the received vectors is decoded by values of rest bits based on a probability equation in the PDA method. The second step of the PDA-SD method is to decode rest elements by applying the SD where the rest elements exclude the element decoded by the PDA.

The conventional PDA-SD method has the great amount of computation due to a repetitional calculation structure.

In Korean Patent No. 10-587457 assigned to ETRI, the same as the assigner of the present invention, a method for detecting a signal in a Multiple Input Multiple Output (MIMO) system having a zero forcing (ZF) detector and a maximum likelihood (ML) detector is disclosed.

Particularly, the detecting method recited in the Korean patent No. 10-587457 includes: a ZF detector for estimating a transmission signal through channel information in a received signal; a first candidate determining part for determining plural constellation dots, being adjacent to the output signal of the ZF detector, as the first candidates of each transmission antenna; a first ML detector for determining the first solution for the received signal from the combination of the first candidates; a second candidate determining part for determining plural constellation dots existing in the direction of the first solution in the output signal of the ZF detector as the second candidates of each transmission; and a second ML detector for detecting the received signal after determining the second solution for the received signal from the combination of the second candidates.

However, the detecting method, recited in the Korean patent No. 10-587457, examines the plural constellation dots, being adjacent to the output signal of the ZF detector. Therefore, when one of the output signals of the ZF detector has bad performance, the adjacent constellation dots may have nothing to do with the transmission signal. That is, total performance can be seriously decreased.

### DISCLOSURE

### Technical Problem

An embodiment of the present invention is directed to providing a detecting apparatus maintains desired system performance and decreases the amount of computation for decoding received signals in a Multiple Input Multiple Output (MIMO) system which transmits and receives a plurality of symbols simultaneously by using multiple antennas and a method thereof.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a detecting apparatus for a Multiple Input Multiple Output (MIMO) system, where M different symbols are transmitted between a transmitter and a receiver through multiple antennas, and M is a natural number, including: a first detector for decoding a received signal, to thereby generate a decoded vector; a candidate elements decision unit for calculating an instantaneous signal-to-interference plus noise ratio (SINR) value for each element of the decoded vector, and deciding candidate elements for estimating a transmission data based on the decoded vector by comparing the calculated instantaneous SINR value and a threshold value; a signal eliminator for generating a signal with respect to the candidate elements determined in the candidate elements decision unit and outputting a modified signal by subtracting the signal from the received signal; and a second detector for decoding the modified signal received from the signal eliminator based on a more precise detection method than the first detector.

In accordance with another aspect of the present invention, there is provided a detecting method in a MIMO system, where M different symbols are transmitted between a transmitter and a receiver through multiple antennas, and M is a natural number, including the steps of: a) performing a first detection of a received signal based on a first detection algorithm having a small computation amount, to thereby generate a decoded vector; b) calculating an instantaneous SINR value for each element of the decoded vector detected in the step a); c) determining elements having the instantaneous SINR value equal to or greater than a threshold value as a candidate elements to be used for estimating a transmission data based on the decoded vector by comparing the calculated instantaneous SINR value and the threshold value; d) generating a signal with respect to the candidate elements determined in the step c) and outputting a modified signal by subtracting the signal from the received signal; and e) performing a second detection of the modified signal based on a more precise second detection algorithm than the first detection algorithm.

In accordance with another aspect of the present invention, there is provided a detecting method in a MIMO system, where M different symbols are transmitted between a transmitter and a receiver through multiple antennas, and M is a natural number, including: a) performing a first detection of a received signal based on a first detection algorithm having a small computation amount, to thereby generate a decoded vector; b) calculating an instantaneous signal-to-interference plus noise ratio (SINR) for each element of the decoded vector detected in the step a); c) determining elements having the instantaneous SINR value equal to or smaller than a threshold value as a candidate elements to be used for estimating a transmission data based on the decoded vector by comparing the calculated instantaneous SINR value and the threshold value; d) generating a signal with respect to the candidate elements determined in the step c) and outputting a modified signal by subtracting the signal from the received signal; and e) performing a second detection of the modified signal based on a more precise second detection algorithm than the first detection algorithm.

### ADVANTAGEOUS EFFECTS

The present invention can maintain desired system performance and decrease the amount of computation for decoding received signals in a communication system which transmits and receives a plurality of symbols simultaneously by using multiple antennas. Also, the present invention can have bit error rate (BER) performance similar to that of a sphere decoding (SD) detection method and decrease the amount of computation for decoding the received signals.

### BRIEF DESCRIPTION OF THE DRAWINGS

FIG. 1 is a block diagram illustrating a detecting apparatus in a Multiple Input Multiple Output (MIMO) system in accordance with an embodiment of the present invention.

FIG. 2 is a flowchart illustrating a detecting method in the MIMO system in accordance with an embodiment of the present invention.

FIG. 3 is a diagram showing the detecting method in accordance with the present invention.

FIG. 4 is a graph showing BER performances of the detecting apparatus in the MIMO system in accordance with the present invention.

FIG. 5 is a graph showing the amount of computation of a conventional detecting apparatus and the detecting apparatus in accordance with the present invention.

### BEST MODE FOR THE INVENTION

The advantages, features and aspects of the invention will become apparent from the following description of the embodiments with reference to the accompanying drawings, which is set forth hereinafter, and thus the invention will be easily carried out by those skilled in the art to which the invention pertains. Also, when it is considered that detailed description on a related art may obscure the points of the present invention unnecessarily in describing the present invention, the description will not be provided herein. Hereinafter, specific embodiments of the present invention will be described with reference to the accompanying drawings.

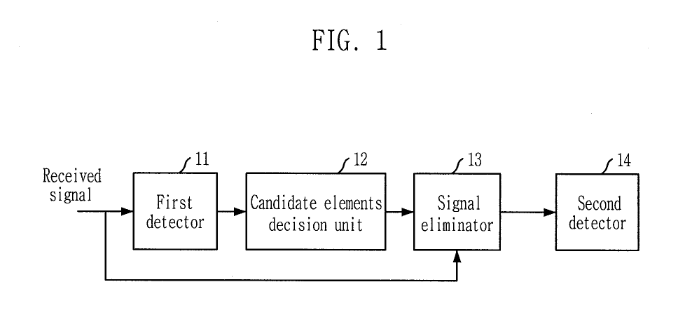

FIG. 1 is a block diagram illustrating a detecting apparatus in a Multiple Input Multiple Output (MIMO) system in accordance with an embodiment of the present invention.

The detecting apparatus includes a first detector 11, a candidate elements decision unit 12, a signal eliminator 13 and a second detector 14. In the present invention, the first detector 11 having a small amount of computation is used for decoding all elements of a received signal. The first detector 11 can be a less complexity detector such as a ZF detector or a MMSE detector.

The candidate elements decision unit 12 calculates instantaneous signal-to-interference plus noise ratio (SINR) for each element decoded in the first detector 11 and compares the calculated instantaneous SINR and a threshold value. Then, the candidate elements decision unit 12 decides elements having instantaneous SINR value greater than the threshold value as candidate elements or elements having instantaneous SINR value smaller than the threshold value as candidate elements.

The signal eliminator 13 generates a signal with respect to the candidate elements based on an estimation vector and a channel value of the candidate elements decided in the candidate elements decision unit 12, and outputs a modified signal by eliminating the generated signal with respect to the candidate elements from an original received signal.

The second detector 14 applies a more precise detection method to the modified signal outputted from the signal eliminator 13 and estimates rest elements excluding the candidate elements. The second detector 14 is a more precise detector than the first detector 11 such as a SD detector or a ML detector.

The detecting apparatus of the present invention will be described in detail.

Herein, the multiple-antenna system is assumed as a vertical bell-labs layered space time (V-BLAST) system in the present invention. That is, the number of the transmitting antennas is n_{T}, and the number of the receiving antennas is n_{R}, where n_{T} is equal to or smaller than n_{R}. Also, one burst includes L symbols, and the channel value does not change for L symbols. That is, variation of the cannel value for L symbols is very small and it can be ignored. Also, a receiving block has channel state information, but a transmitting block does not have the channel state information. Under the above assumptions, a complex received signal \tilde{r} can be expressed as the following Eq. 1.

$$\tilde{r} = \sqrt{\frac{ρ}{{n}_{T}}} \tilde{A} \tilde{s} + \tilde{n} = \tilde{H} \tilde{s} + \tilde{n} \qquad Eq . 1$$

Herein, \tilde{s}=[\tilde{s}₁, \tilde{s}₂ . . . \tilde{s}₂ₙ_{_{T}}]^{T} is a complex transmission signal vector having a dimension n_{T}×1; \tilde{r}=[\tilde{r}₁ \tilde{r}₂ . . . \tilde{r}₂ₙ_{_{T}}]^{T} is a complex reception signal vector having a dimension n_{R}×1; Ã is a complex channel matrix including complex channel values ãᵢⱼ as elements and has a dimension of n_{R}×n_{T}; ñ is a white Gaussian circularly symmetric noise having a dimension n_{R}×1 and variance 2σ²I, where I is a unit matrix; ρ denotes transmission power. Also, obstacles dispersing electric waves are infinite between the transmitting antennas and the receiving antennas in the channel state. Therefore, a real part and an imaginary part for each element ãᵢⱼ of the complex channel matrix have of which average value is 0, and variance is 1 Gaussian independent identically distribution.

For the vectors and the matrixes as defined above, each element can be divided into the real part and the imaginary part. Therefore, vectors and matrixes having only real parts can be defined as the following Eq. 2.

$$s = {[ Re ( {\tilde{s}}^{T} ) Im ( {\tilde{s}}^{T} ) ]}^{T} \\ r = {[ Re ( {\tilde{r}}^{T} ) Im ( {\tilde{r}}^{T} ) ]}^{T} \\ A = [ \begin{matrix}Re ( {\tilde{A}}^{T} ) & - Im ( {\tilde{A}}^{T} ) \\ Im ( {\tilde{A}}^{T} ) & Re ( {\tilde{A}}^{T} )\end{matrix} ] \\ n = {[ Re ( {\tilde{n}}^{T} ) Im ( {\tilde{n}}^{T} ) ]}^{T} \qquad Eq . 2$$

Herein, Re(•) denotes real parts of each element; Im(•) denotes imaginary parts of each element; and (•)^{T} denotes a transpose matrix.

Eq. 1 can be expressed as the following Eq. 3 having real element values based on Eq. 2.

$$r = \sqrt{\frac{ρ}{{n}_{T}}} As + n = Hs + n \qquad Eq . 3$$

Herein, r has a dimension 2n_{R}×1; H has a dimension 2n_{R}×2n_{T}; s has a dimension 2n_{T}×1; and n has a dimension 2n_{R}×1.

Applying a sphere decoding (SD) to estimate s, needs a large amount of computation. Therefore, the first detector 11, which is comparatively simple, and the second detector 14, which is comparatively precise, are used to estimate s in the present invention.

At first step, a detection of the received signal is performed based on the first detector 11. The first detector can be the ZF detector or the MMSE detector having a smaller amount of computation than the SD.

Hereinafter, the MMSE detector will be described as the first detector. However, other detectors can be used as the first detector.

After the MMSE detector is applied to the received signal based on channel state information matrix H and an output signal ŝ_{MMSE} of the MMSE detector is expressed as the following Eq. 4.

$${\hat{s}}_{MMSE} = {{H}^{T} ( {HH}^{T} + \frac{{σ}^{2}}{{ρ}^{2}} I )}^{- 1} r , {σ}^{2} \text{:} noise variance \qquad Eq . 4$$

Herein, (•)⁻¹ denotes an inverse matrix.

The output signal of the first detector is defined as the following Equation.

ŝ_{MMSE}=[Re{ŝ₁}Re{ŝ₂} . . . Re{ŝₙ_{_{T}}}Im{ŝ₁}Im{ŝ₂} . . . Im{ŝₙ_{_{T}}}]^{T}

The candidate elements decision unit 12 calculates the instantaneous SINR value for each element of a vector decoded in the first detector 11. The instantaneous SINR value can be acquired based on the following Eq. 5.

$${SINR}_{k} = \frac{{‖ {g}_{k}^{H} {h}_{k} ‖}^{2}}{{g}_{k}^{H} {H}_{k}^{H} {H}_{k} {g}_{k} + 2 {σ}^{2} ( {g}_{k}^{H} {g}_{k} )} , k = 1 , 2 , … , 2 {n}_{T} \\ G = {( {HH}^{T} + \frac{{σ}^{2}}{{ρ}^{2}} I )}^{- 1} H = [ \begin{matrix}{g}_{1} & {g}_{2} & … & {g}_{2 {n}_{T}}\end{matrix} ] \\ H = ⌊ \begin{matrix}{h}_{1} & {h}_{2} & … & {h}_{2 {n}_{T}}\end{matrix} ⌋ , \\ {H}_{k} = [ \begin{matrix}{h}_{1} & … & {h}_{k - 1} & {h}_{k + 1} & … & {h}_{2 {n}_{T}}\end{matrix} ] \qquad Eq . 5$$

Herein, G means the MMSE detector.

The candidate elements decision unit 12 compares a threshold value with a SINRₖ value of each element with respect to decoded vector ŝ_{MMSE} of the MMSE detector acquired based on Eq. 5, and determines the number of elements ‘m’ which are directly used in order to estimate transmission data based on the decoded vector of the MMSE detector. There are two methods for determining ‘m’. First, the number of elements having SINR value equal to or greater than the threshold value can be determined as ‘m’. On the other hand, the number of elements having SINR value equal to or smaller than the threshold value can be determined as ‘m’.

The m elements which are directly used in order to estimate the transmission data based on the decoded vector of the MMSE detector as above description, are defined as s_{D}, and rest elements are defined as s _{D̅}. The received signal r is expressed as the following Eq. 6.

$$r = [ \begin{matrix}{H}_{D} & {H}_{\overline{D}}\end{matrix} ] [ \begin{matrix}{s}_{D} \\ {s}_{\overline{D}}\end{matrix} ] + n \qquad Eq . 6$$

The candidate elements decision unit 12 compares 0 and each of m elements which are directly used in order to estimate the transmission data based on the decoded vector of the MMSE detector and estimates ŝ_{D}.

The signal eliminator 13 receives the estimation value matrix ŝ_{D} for the m elements which are directly used in order to estimate the transmission data based on the decoded vector of the MMSE detector from the candidate elements decision unit 12, generates a signal with respect to ŝ_{D} based on channel value H_{D} and ŝ_{D}, and outputs a modified signal by eliminating the generated signal from an original received signal.

Operation of the signal eliminator 13 can be expressed as the following Eq. 7.

r _{D̅}=r−H_{D}ŝ_{D} Eq. 7

When the ŝ_{D} is estimated to be close to s_{D}, r _{D̅} has no component of s_{D} as the following Eq. 8.

r _{D̅}=r−H_{D}ŝ_{D}=H _{D̅}s _{D̅}+n Eq. 8

The second detector 14 is a more precise detector than the first detector 11, e.g., the SD detector. The second detector 14 receives the modified signal from the signal eliminator 13 and performs the detection of the modified signal. The modified signal is acquired by eliminating the vector elements decoded in the first detector from the original received signal.

That is, the second detector 14 applies a more precise detection method such as the SD to the modified signal r _{D̅} and estimates ŝ _{D̅}. A distance d between the decoded vector ŝ_{MMSE} of the first detector and received vector r can be defined and expressed as d=∥r−ŝ_{MMSE}∥ for determining an initial radius C of the SD. Also, a circular with a radius C considers a diagonal distance

$$\frac{a}{\sqrt{2}}$$

between points on the constellation in order to include at least one point on the constellation, where ‘a’ is a predetermined value based on the modulation method. The initial radius C of the SD is determined as

$$‵ d + \frac{a}{\sqrt{2}} ′ .$$

Therefore, a first estimation value of elements with respect to the decoded vector detected by the first detector and a second estimation value of rest elements detected by the second detector are combined and the final vector of the received signal is determined.

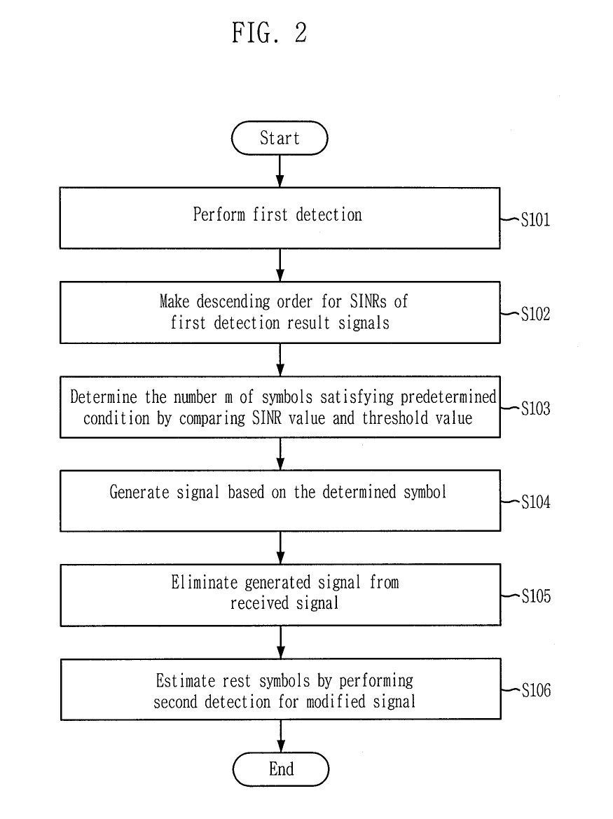

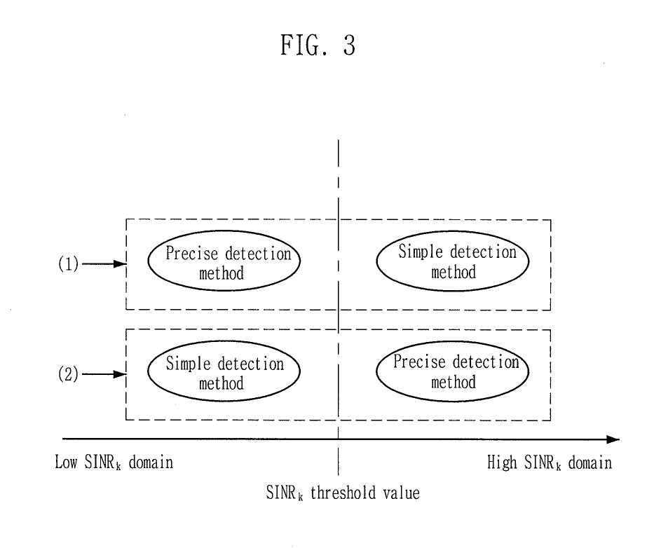

FIG. 2 is a flowchart illustrating a detecting method in the MIMO system in accordance with an embodiment of the present invention; and FIG. 3 is a diagram showing the detecting method in accordance with the present invention.

First, a decoding vector is generated by performing a first detection of a received signal based on a ZF detection algorithm or a MMSE detection algorithm having a small amount of computation than a SD detection algorithm at step S101.

Then, instantaneous signal-to-interference plus noise ratios (SINR) for each element of the decoding vector generated by the first detection are calculated, and the instantaneous SINRs are sorted according to descending order at step S102.

Then, a threshold value and a SINR value for each element of the decoding vector generated by the first detection are compared and the number of candidate elements ‘m’ is determined for estimating a transmission data based on a first detection result at step S103. Herein, the number of candidate elements ‘m’ can be determined as elements having the instantaneous SINR value equal to or greater than the threshold value or determined as elements having the instantaneous SINR value equal to or smaller than the threshold value.

When the candidate elements for estimating the transmission data based on the first detection result are determined, a corresponding signal with respect to the m elements is generated at step S104.

Then, a modified signal is generated by eliminating the signal with respect to the m elements from an original received signal at step S105. Therefore, reset elements whose symbol is not estimated remain in the modified signal by eliminating the signal whose symbol is estimated by the first detection.

Then, a second detection of the modified signal is performed based on a more precise detection algorithm than the first detection algorithm and rest symbols are estimated at step S106.

Dimension of signal inputted to a SD detector can be decreased based on the first MMSE detector, so the amount of computation can be decreased. That is, as the dimension of the received signal increase, computation amount of the SD detector increases by geometric progression.

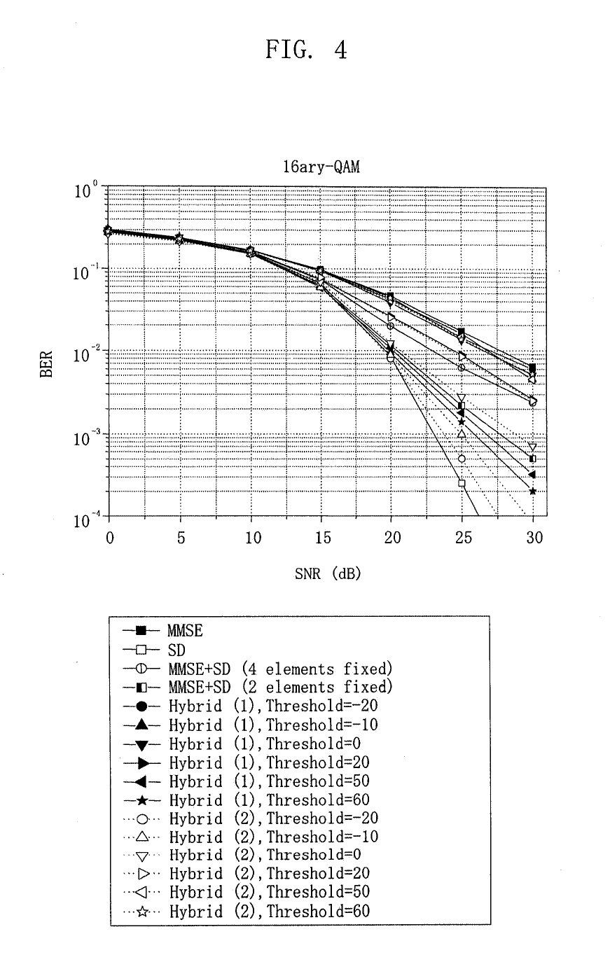

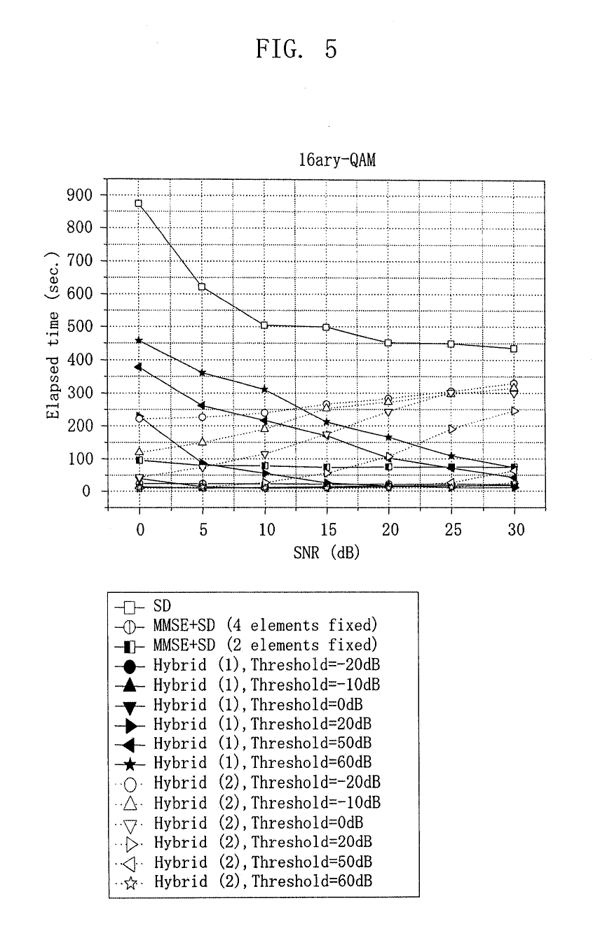

FIGS. 4 and 5 represent bit error rate (BER) and amount of computation, respectively, when the MMSE detector is applied as the first detector and the SD detector is applied as the second detector in the detecting apparatus of the present invention.

FIG. 4 is a graph showing the BER of the present invention and the conventional MMSE detection method and the SD detection method when each threshold value is −20 dB, −10 dB, 0 dB, 20 dB, 50 dB and 60 dB, respectively. A y axis represents an average SNR value for the receiving antennas and an x-axis represents the BER. Herein, small BER of the x axis presents better performance.

FIG. 5 is a graph showing the amount of computation for each case of FIG. 4. A y axis represents a measurement value of simulation execution time by second unit. As the measurement value is large, the amount of computation is large. Also, ‘MMSE+SD 4 element fixed’ and ‘MMSE+SD 2 element fixed’ denote the number of element for estimating the transmission data based on the MMSE results fixed with 4 and 2, respectively, while the MMSE detector is applied as the first detector and the SD detector is applied as the second detector.

‘Hybrid (1)’ represents a result when the m elements determined by element having the instantaneous SINR value equal to or greater than the threshold value, and ‘Hybrid (2)’ represents a result when the m elements determined by element having the instantaneous SINR value equal to or smaller than the threshold value. As shown in FIGS. 4 and 5, as the threshold value increases, the BER is good but the amount of computation is increased in case of the ‘Hybrid (1)’. On the other hand, as the threshold value decreases, the BER is bad but the amount of computation is decreased in case of the ‘Hybrid (2)’. Also, the detection method of the present invention has always a smaller amount of computation than the SD detection method regardless of the magnitude of the threshold value as shown in FIG. 5.

The above described method according to the present invention can be embodied as a program and be stored on a computer readable recording medium. The computer readable recording medium is any data storage device that can store data which can be read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application Nos. 2006-0079546 and 2006-0112379, filed in the Korean Intellectual Property Office on Oct. 22, 2006, and Nov. 14, 2006, respectively, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A detecting apparatus for a Multiple Input Multiple Output (MIMO) system, where M different symbols are transmitted between a transmitter and a receiver through multiple antennas, and M is a natural number, comprising:
a first detecting means for decoding a received signal, to thereby generate a decoded vector;
a candidate elements decision means for calculating an instantaneous signal-to-interference plus noise ratio (SINR) value for each element of the decoded vector, and deciding candidate elements for estimating a transmission data based on the decoded vector by comparing the calculated instantaneous SINR value and a threshold value;
a signal eliminating means for generating a signal with respect to the candidate elements determined in the candidate elements decision means and outputting a modified signal by subtracting the signal from the received signal; and
a second detecting means for decoding the modified signal received from the signal eliminating means based on a more precise detection method than the first detecting means.

2. The apparatus of claim 1, wherein the candidate elements decision means determines elements having the instantaneous SINR value equal to or greater than the threshold value as the candidate elements to be used for estimating the transmission data based on the decoded vector.

3. The apparatus of claim 2, wherein the first detecting means is a zero forcing (ZF) detector.

4. The apparatus of claim 2, wherein the first detecting means is a minimum mean-squared estimate (MMSE) detector.

5. The apparatus of claim 2, wherein the second detecting means is a sphere decoding (SD) detector.

6. The apparatus of claim 2, wherein the second detecting means is a maximum likelihood (ML) detector.

7. The apparatus of claim 1, wherein the candidate elements decision means determines elements having the instantaneous SINR value equal to or smaller than the threshold value as the candidate elements for estimating the transmission data based on the decoded.

8. The apparatus of claim 7, wherein the first detecting means is a zero forcing (ZF) detector.

9. The apparatus of claim 7, wherein the first detecting means is a minimum mean-squared estimate (MMSE) detector.

10. The apparatus of claim 7, wherein the second detecting means is a sphere decoding (SD) detector.

11. The apparatus of claim 7, wherein the second detecting means is a maximum likelihood (ML) detector.

12. A detecting method in a Multiple Input Multiple Output (MIMO) system, where M different symbols are transmitted between a transmitter and a receiver through multiple antennas, and M is a natural number, comprising the steps of:
a) performing a first detection of a received signal based on a first detection algorithm having a small computation amount, to thereby generate a decoded vector;
b) calculating an instantaneous signal-to-interference plus noise ratio (SINR) value for each element of the decoded vector detected in the step a);
c) determining elements having the instantaneous SINR value equal to or greater than a threshold value as a candidate elements to be used for estimating a transmission data based on the decoded vector by comparing the calculated instantaneous SINR value and the threshold value;
d) generating a signal with respect to the candidate elements determined in the step c) and outputting a modified signal by subtracting the signal from the received signal; and
e) performing a second detection of the modified signal based on a more precise second detection algorithm than the first detection algorithm.

13. The method of claim 12, wherein the first detection algorithm is a zero forcing (ZF) detection algorithm.

14. The method of claim 12, wherein the first detection algorithm is a minimum mean-squared estimate (MMSE) detection algorithm.

15. The method of claim 12, wherein the second detection algorithm is a sphere decoding (SD) detection algorithm.

16. The method of claim 12, wherein the second detection algorithm is a maximum likelihood (ML) detection algorithm.

17. A detecting method in a Multiple Input Multiple Output (MIMO) system, where M different symbols are transmitted between a transmitter and a receiver through multiple antennas, and M is a natural number, comprising:
a) performing a first detection of a received signal based on a first detection algorithm having a small computation amount, to thereby generate a decoded vector;
b) calculating an instantaneous signal-to-interference plus noise ratio (SINR) for each element of the decoded vector detected in the step a);
c) determining elements having the instantaneous SINR value equal to or smaller than a threshold value as a candidate elements to be used for estimating a transmission data based on the decoded vector by comparing the calculated instantaneous SINR value and the threshold value;
d) generating a signal with respect to the candidate elements determined in the step c) and outputting a modified signal by subtracting the signal from the received signal; and
e) performing a second detection of the modified signal based on a more precise second detection algorithm than the first detection algorithm.
